(19) United States
(12) Patent Application Publication
(10) Pub. No.: US 2022/0099016 A1
(43) Pub. Date: Mar. 31, 2022

(54) SWITCHABLE MECHANICAL MOTOR VEHICLE COOLANT PUMP

(71) Applicant: PIERBURG PUMP TECHNOLOGY GMBH, NEUSS (DE)

(72) Inventors: LAURENT FINIDORI, BERTRANGE (FR); GILLES SIMON, MONTOIS LA MONTAGNE (FR); RAFFAELE SQUARCINI, LIVORNO (IT); EMMANUEL DATTOLI, POMMERIEUX (FR); SEBASTIEN BRUANT, POMMERIEUX (FR); GILLES RYBICKI, METZ (FR); GIORGIO PERONI, PISA (IT); ANTONIO DIPACE, DUESSELDORF (DE); JEROME KREMER, INGLANGE (FR)

(73) Assignee: PIERBURG PUMP TECHNOLOGY GMBH, NEUSS (DE)

(21) Appl. No.: 17/421,024

(22) PCT Filed: Jan. 15, 2019
(86) PCT No.: PCT/EP2019/050958

§ 371 Date: Jul. 7, 2021

(51) Int. Cl. F01P 7/14; F01P 5/12; F04D 15/00

(52) U.S. Cl. CPC F01P 7/14; F01P 2007/146; F04D 15/0038; F01P 5/12

(57) ABSTRACT

A switchable mechanical motor vehicle coolant pump includes a rotatable drive shaft, a drive wheel, a coolant pump wheel comprising a radially outer outlet, a control slider, and an actuation system which hydraulically actuates the control slider. The drive wheel and the coolant pump wheel are each connected to the drive shaft. The control slider shifts axially with respect to the coolant pump wheel to at least partially close the radially outer outlet. The actuation system includes pressure chamber(s), an auxiliary pump having an auxiliary pump wheel provided integrally with the coolant pump wheel, and a switchable control valve which controls a pressure level within the pressure chamber(s). The auxiliary pump wheel provides a hydraulic actuation pressure for the pressure chamber(s) and comprises a ring-shaped pumping channel in which pumping vanes are arranged equidistantly along a circumference of the ring-shaped pumping channel so as to define equal pumping chambers therebetween.

### CROSS REFERENCE TO PRIOR APPLICATIONS

This application is a U.S. National Phase application under 35 U.S.C. § 371 of International Application No. PCT/EP2019/050958, filed on Jan. 15, 2019. The International Application was published in English on Jul. 23, 2020 as WO 2020/147936 A1 under PCT Article 21(2).

### FIELD

The present invention is directed to a switchable mechanical motor vehicle coolant pump with a coolant pump wheel and a cylindrical control slider which is axially shiftable with respect to the coolant pump wheel so that a radially outer outlet of the coolant pump wheel is at least partially closeable.

### BACKGROUND

Such coolant pumps are used in motor vehicles to control the pumped coolant flow, and in particular to avoid an overheating of an internal combustion engine of the motor vehicle. Such coolant pumps are typically mechanically driven by the engine via a belt drive or via a chain drive so that the coolant pump wheel always rotates with a rotational speed which is equal to or directly proportional to the rotational speed of the crankshaft of the engine.

In modern engines, an adaptation of the pumped coolant flow to the coolant requirement of the engine and/or of the motor vehicle is, however, desired. In this case, the cold start phase of the engine should in particular be shortened to minimize the fuel consumption of and the pollutants emitted by the engine. This is provided by throttling or even stopping the coolant flow during the cold start phase.

Various concepts for controlling the pumped coolant flow have previously been described. In addition to electrically driven coolant pumps, mechanically driven coolant pumps have previously been described which are provided with clutch arrangements, in particular with hydrodynamic clutch arrangements, to selectively couple/decouple the coolant pump wheel to/from the driving engine crankshaft. A cost-efficient and simple concept for controlling the pumped coolant flow is to provide the coolant pump with an axially shiftable control slider. The control slider is axially shiftable over the pump wheel so that a radially outer pump wheel outlet is completely or at least partially closeable by the control slider. The effective outlet flow cross section of the pump wheel and, thereby, the pumped coolant flow, can thereby be controlled by controlling the axial position of the control slider.

Various concepts to actuate the control slider have also previously been described. Hydraulic control slider actuation concepts are in particular used in addition to a purely electrical control slider actuation. Hydraulic control slider actuation is typically realized via a ring-shaped pressure chamber being, and is typically provided with a pressurized coolant. One axial side of the pressure chamber is defined by an axially shiftable piston element which is co-movably connected with the control slider. The control slider is as a result axially shifted into a closed position in which the control slider radially surrounds the pump wheel if the pressure chamber is loaded with an actuation pressure. The control slider typically axially preloads towards an open position via a preload spring so that the control slider is axially shifted back into the open position if a pressure chamber outlet is opened, for example, towards atmospheric pressure. The fluidic opening/closing of the pressure chamber outlet is controlled by a control valve.

The coolant pump can be alternatively be provided with two separate pressure chambers which are arranged so that the control slider is shifted into a first axial direction if the first pressure chamber is provided with a higher pressure level compared to the second pressure chamber, and is shifted into an opposite second axial direction if the second pressure chamber is provided with a higher pressure level compared to the first pressure chamber. The control valve in this case controls the axial control slider position by controlling the ratio between the pressure levels of the first and the second pressure chamber.

Switchable mechanical coolant pumps have previously been described which are provided with an auxiliary pump wheel arranged on the drive shaft. The auxiliary pump wheel provides the hydraulic actuation pressure required for the hydraulic actuation of the control slider so that no separate pumping unit such as, for example, an additional piston/cylinder unit, must be provided.

Such a motor vehicle coolant pump is, for example, described in WO 2017/076645 A1. The coolant pump is provided with a rotatable drive shaft, a drive wheel which is co-rotatably connected with the drive shaft, and a coolant pump wheel which is co-rotatably connected with the drive shaft. The coolant pump also comprises a cylindrical control slider which is axially shiftable with respect to the coolant pump wheel so that a radially outer outlet of the coolant pump wheel is at least partially closeable. The coolant pump is also provided with a hydraulic actuation system for the hydraulic actuation of the control slider.

The hydraulic actuation system comprises an auxiliary pump for providing a hydraulic actuation pressure. The auxiliary pump comprises an auxiliary pump wheel which is integrally provided with the coolant pump wheel. The auxiliary pump wheel is provided with several pumping vanes which are disposed along the circumference of the auxiliary pump wheel with a uniform circumferential distance and which axially protrude from the backside of the coolant pump wheel. The hydraulic actuation system also comprises a switchable control valve for controlling the pressure level within a pressure chamber and, as a result, for controlling the axial control slider position.

The described auxiliary pump can provide the hydraulic pressure which is required to actuate the control slider, however, the auxiliary pump has a relatively low hydraulic efficiency. The auxiliary pump therefore generates a relatively high hydraulic power loss which significantly reduces the overall efficiency of the coolant pump.

### SUMMARY

An aspect of the present invention is to provide an energy-efficient switchable mechanical motor vehicle coolant pump which provides for a reliable control of the pumped coolant flow.

In an embodiment, the present invention provides a switchable mechanical motor vehicle coolant pump which includes a rotatable drive shaft, a drive wheel which is co-rotatably connected with the rotatable drive shaft, a coolant pump wheel comprising a radially outer outlet, the coolant pump wheel being co-rotatably connected with the rotatable drive shaft, a cylindrical control slider, and a hydraulic actuation system which is configured to hydraulically actuate the cylindrical control slider. The cylindrical control slider is configured to be axially shiftable with respect to the coolant pump wheel so that the radially outer outlet is at least partially closeable. The hydraulic actuation system comprises at least one pressure chamber, an auxiliary pump comprising an auxiliary pump wheel which is provided integrally with the coolant pump wheel, and a switchable control valve which is configured to control a pressure level within the at least one pressure chamber. The auxiliary pump wheel is configured to provide a hydraulic actuation pressure for the at least one pressure chamber. The auxiliary pump wheel comprises a ring-shaped pumping channel in which a plurality of pumping vanes is arranged. The respective individual pumping vanes of the plurality of pumping vanes are arranged equidistantly along a circumference of the ring-shaped pumping channel so as to define a plurality of equal pumping chambers therebetween.

### BRIEF DESCRIPTION OF THE DRAWINGS

The present invention is described in greater detail below on the basis of embodiments and of the drawings in which:

FIG. 1 shows a side view of a switchable mechanical motor vehicle coolant pump according to the present invention in a partially sectioned representation;

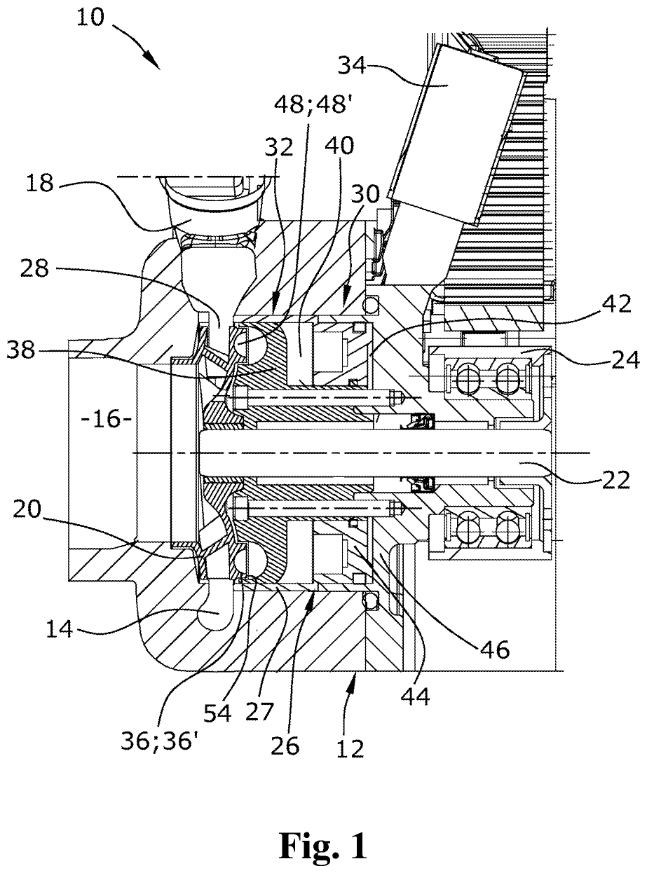

FIG. 2 shows a perspective view of a first embodiment of an auxiliary pump wheel of the coolant pump of FIG. 1;

FIG. 3 shows a perspective view of a second embodiment of an auxiliary pump wheel of the coolant pump of FIG. 1; and

FIG. 4 shows a top view of the auxiliary pump wheel of FIG. 3.

### DETAILED DESCRIPTION

The switchable mechanical motor vehicle coolant pump according to the present invention is provided with a rotatable drive shaft and with a drive wheel which is co-rotatably connected with the drive shaft and which is mechanically drivable by an internal combustion engine of the motor vehicle. The drive wheel can, for example, be a pulley wheel which is coupled with a crankshaft of the engine by a drive belt, or the drive wheel can be a gear wheel which is mechanically coupled with the engine via a gearing. The drive wheel and, as a result, the drive shaft in any case always rotate at a rotational speed which is equal to or directly proportional to the engine speed.

The switchable mechanical motor vehicle coolant pump according to the present invention is also provided with a main coolant pump wheel which is co-rotatably connected with the drive shaft. The coolant pump wheel can be directly connected with the drive shaft or can alternatively be selectively couplable with the drive shaft via a coupling arrangement. The coolant pump wheel is typically disposed at an axial end of the drive shaft. The coolant flows via an axial pump inlet against a pump-inlet-facing axial side of the coolant pump wheel. The coolant pump wheel is designed so that a pressurized coolant is providable to a radially outer flow channel of the coolant pump by rotation of the coolant pump wheel. The coolant pump wheel pumps the liquid coolant within a cooling circuit of the engine.

The switchable mechanical motor vehicle coolant pump according to the present invention is also provided with an axially shiftable and cylindrical control slider. The control slider is designed and arranged so that the control slider can be shifted over the coolant pump wheel as needed so that a radially outer outlet of the coolant pump wheel is at least partially closeable by the control slider. The pumped coolant flow of the coolant pump is thereby controllable via the axial position of the control slider.

The switchable mechanical motor vehicle coolant pump according to the present invention is also provided with a hydraulic actuation system for the hydraulic actuation of the control slider. The hydraulic actuation system comprises at least one pressure chamber, wherein the axial control slider position is controlled by controlling the pressure level within the at least one pressure chamber. The control slider is typically substantially pot-shaped, wherein the at least one pressure chamber is defined at one axial side by a transversal bottom wall of the control slider so that the control slider is directly loaded with the pressure of the pressure chamber. The control slider can alternatively be co-movably connected with a piston element defining one axial side of the pressure chamber and, as a result, being loaded with the pressure chamber pressure.

The actuation system can be provided with a single pressure chamber which is selectively loadable with the actuation pressure to shift the control slider over the pump wheel as needed. The force which is required for the reset movement of the control slider is in this case typically provided by a preload spring. The actuation system can alternatively be provided with two separate pressure chambers located at opposite axial sides of the control slider bottom wall. The axial control slider position is controlled in this case via controlling the ratio between the pressure levels of the two pressure chambers.

The hydraulic actuation system also comprises a fluidically separate auxiliary pump for providing the actuation pressure for the at least one pressure chamber. The auxiliary pump is provided with an auxiliary pump wheel which is integrally provided with the coolant pump wheel. As a result, the auxiliary pump wheel is directly and undetachably connected with the coolant pump wheel so that the auxiliary pump reliably provides the hydraulic actuation pressure during the coolant pump operation. The auxiliary pump wheel is typically located at the pump-inlet-remote axial backside of the coolant pump wheel so that only a small axial installation space is required for the auxiliary pump. No additional support means and/or assembly steps are moreover required for the support of the auxiliary pump wheel.

The hydraulic actuation system also comprises a switchable control valve for controlling the pressure level within the at least one pressure chamber and, as a result, for controlling the axial control slider position. The control valve can, for example, be a multi-way valve which is located at a pressure chamber inlet. The pressure chamber pressure level is in this case controlled by selectively fluidically connecting the pressure chamber with the actuation pressure provided by the auxiliary pump or with a low pressure as, for example, atmospheric pressure or the pump inlet pressure. The pressure chamber can alternatively be directly fluidically connected with the actuation pressure of the auxiliary pump. The control valve is in this case typically a two-way valve which is arranged at an outlet of the pressure chamber, wherein the pressure chamber pressure level is controlled by selectively fluidically connecting the pressure chamber outlet with the low pressure. The control valve is typically an electrically switchable solenoid valve so that the pressure chamber pressure level and, as a result, the axial control slider position is electrically controllable.

According to the present invention, the auxiliary pump wheel is provided with a ring-shaped pumping channel in which a plurality of pumping vanes is arranged. The pumping vanes are evenly distributed along the circumference of the pumping channel, i.e., are disposed with a uniform circumferential distance between them, and define a plurality of circumferentially adjacent pumping chamber between them. The auxiliary pump wheel according to the present invention generates only a low hydraulic power loss compared to the total power consumption of the coolant pump so that the coolant pump has a high total hydraulic efficiency. This allows an energy-efficient actuation of the control slider and, as a result, provides an energy-efficient motor vehicle coolant pump. Since the auxiliary pump wheel is integrally provided with the coolant pump wheel, the auxiliary pump provides a reliable actuation pressure provision so that the motor vehicle coolant pump according to the present invention provides a reliable control of the pumped coolant flow.

In an embodiment of the present invention, the auxiliary pump can, for example, be a side channel pump which only requires a small axial installation space. The side channel pump can also be integrally provided with the coolant pump wheel in a simple manner.

The pumping channel of the auxiliary pump wheel can, for example, be provided with a circle-segment-shaped cross section. This reduces the hydraulic losses of the auxiliary pump and, as a result, provides an energy-efficient motor vehicle coolant pump.

In an embodiment of the present invention, each pumping vane of the auxiliary pump wheel can, for example, be completely arranged inside of the pumping channel and, in particular, to not axially project out of the pumping channel. This provides a compact auxiliary pump wheel with low hydraulic losses.

Typical solenoid valves can only switch/interrupt a fluid flow up to a defined maximum fluid pressure level. A reliable function of the solenoid valve is therefore not guaranteed if the fluid pressure level is higher than the defined maximum fluid pressure level. A radially outer side wall of each pumping chamber can, for example, be provided with a discharge channel which fluidically connects the pumping chamber with the radial outside of the auxiliary pump wheel. The discharge channel provides a defined fluidic bypass which limits the actuation pressure provided by the auxiliary pump to a defined maximum actuation pressure level which is lower than the maximum fluid pressure level of the solenoid valve. The solenoid valve can thereby always reliably control the coolant flow into/out of the pressure chamber and can therefore reliably control the axial control slider position.

Each discharge channel can, for example, be tilted with respect to a corresponding radial plane by a defined channel tilting angle so that a radially inner discharge channel end is circumferentially displaced with respect to a radially outer discharge channel end toward a rotational direction of the pump wheel. The channel tilting angle defines the tilting of the discharge channel with respect to the radial plane which extends through the inner discharge channel end. The tilted discharge channels reduce the hydraulic losses of the auxiliary pump wheel and thereby provide an energy-efficient motor vehicle coolant pump.

In an embodiment of the present invention, each pumping vane can, for example, be tilted with respect to a corresponding radial plane by a defined vane tilting angle so that a radially inner pumping vane end is circumferentially displaced with respect to a radially outer pumping vane end toward the rotational direction of the pump wheel. The vane tilting angle defines the tilting of the pumping vane with respect to the radial plane which extends through the inner pumping vane end. The tilted pumping vanes reduce the hydraulic losses of the auxiliary pump wheel and thereby provide an energy-efficient motor vehicle coolant pump.

The channel tilting angle can, for example, be larger than the vane tilting angle. This minimizes the hydraulic losses of the auxiliary pump wheel.

In an embodiment of the present invention, each pumping vane of the auxiliary pump wheel can, for example, extend in a radial plane. This provides a mechanically robust auxiliary pump wheel which can be manufactured in a simple manner.

Different embodiments of the present invention are described below with reference to the enclosed drawings.

The motor vehicle coolant pump 10 according to the present invention is provided with a pump housing 12 which defines a spiral flow channel 14, an axial pump inlet 16, and a tangential pump outlet 18. A coolant is sucked into the coolant pump 10 via the pump inlet 16, and is provided to a (not shown) coolant circuit of an internal combustion engine via the pump outlet 18.

A coolant pump wheel 20 is provided radially inside of the flow channel 14. The coolant pump wheel 20 is co-rotatably connected with a drive shaft 22 which is rotatably supported in the pump housing 12. The coolant pump wheel 20 is a radial flow pump wheel in the shown embodiment of the present invention. The drive shaft 22 is co-rotatably connected with a drive wheel 24 which, in the shown embodiment of the present invention, is a pulley wheel which is connected with the engine via a (not shown) drive belt.

The coolant pump 10 comprises a substantially pot-shaped control slider 26 with a substantially cylindrical control slider side wall 27 and with a substantially transversal control slider bottom wall 44. The control slider 26 is axially shiftable between a closed position and an open position. In the closed position, the control slider side wall 27 radially encloses the coolant pump wheel 20 so that a radially outer outlet 28 of the coolant pump wheel 20 is substantially completely closed. In the open position, the control slider 26 is axially displaced with respect to the closed position in the direction that faces away from the pump inlet 16, wherein the control slider 26 is displaced so that the outer outlet 28 of the coolant pump wheel 20 is substantially completely opened. The pumped coolant flow of the coolant pump 10 is as a result controllable by controlling the axial position of the control slider 26.

The coolant pump 10 is provided with a hydraulic actuation system 30 for the hydraulic actuation of the control slider 26. The hydraulic actuation system 30 comprises an auxiliary pump 32 and a switchable control valve 34. The auxiliary pump 32 is provided with an auxiliary pump wheel 36 and an auxiliary pump housing 38 which, in the shown embodiment of the present invention, together provide a side channel pump. The control valve 34 is a 3/2-way solenoid valve in the shown embodiment of the present invention.

In the shown embodiment of the present invention, the auxiliary pump 32 is designed to provide two different actuation pressure levels, a high actuation pressure PH and a low actuation pressure PL; this is realized by two different auxiliary pump outlets being arranged at different circumferential positions. The auxiliary pump 32 utilizes the coolant as a hydraulic liquid.

The auxiliary pump wheel 36 is integrally provided with the coolant pump wheel 20, wherein the auxiliary pump wheel is provided at a pump-inlet-remote axial backside of the coolant pump wheel 20. The auxiliary pump wheel 36 and the coolant pump wheel 20 therefore always rotate with the same rotational speed so that the auxiliary pump 32 reliably provides the actuation pressures PH, PL as soon as the coolant pump 10 is active.

The hydraulic actuation system 30 also comprises two pressure chambers 40, 42. The first pressure chamber 40 is located at a pump-inlet-facing axial side of the transversal control slider bottom wall 44 and is axially defined by the auxiliary pump housing 38 and by the transversal control slider bottom wall 44. The second pressure chamber 42 is located at the opposite pump-inlet-remote axial side of the transversal control slider bottom wall 44 and is axially defined by the transversal control slider bottom wall 44 and by a transversal pump housing wall 46 of the pump housing 12.

The first pressure chamber 40 is continuously loaded with the low actuation pressure PL. The pressure level of the second pressure chamber 42 is controllable by the control valve 34 between atmospheric pressure PA and the high actuation pressure PH. If the pressure level of the second pressure chamber 42 is lower than the low actuation pressure PL and, as a result, is lower than the pressure level of the first pressure chamber 40, the control slider 26 is axially shifted away from the pump inlet 16 and, as a result, is shifted toward the open position. If the pressure level of the second pressure chamber 42 is higher than the low actuation pressure PL and, as a result, is higher than the pressure level of the first pressure chamber 40, the control slider 26 is axially shifted toward the pump inlet 16 and, as a result, is shifted toward the closed position. The axial position of the control slider 26 and therefore the pumped coolant flow is therefore controllable by the control valve 34.

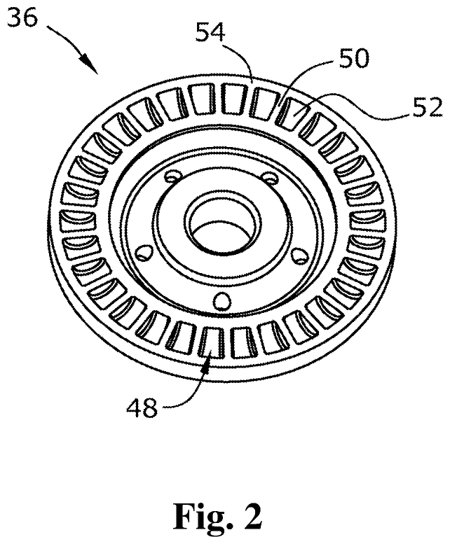

FIG. 2 shows a first embodiment of the auxiliary pump wheel 36. The auxiliary pump wheel 36 is provided with a ring-shaped pumping channel 48. The pumping channel 48 is provided with a circle-segment-shaped radial cross section and radially surrounds the drive wheel 24. The auxiliary pump wheel 36 also comprises a plurality of pumping vanes 50 which are arranged inside of the pumping channel 48, wherein the pumping vanes 50 are evenly distributed along the circumference of the pumping channel 48. The pumping vanes 50 are integrally provided with the auxiliary pump wheel 36, and define a plurality of circumferentially adjacent pumping chambers 52 between them. Each pumping vane 50 substantially extends in a radial plane and does not axially project out of the pumping channel 48. Each pumping vane 50 in particular ends substantially flush, i.e., step-free, with a transversal auxiliary pump wheel surface 54 of the auxiliary pump wheel 36. All pumping vanes 50 are therefore completely located inside of the pumping channel 48.

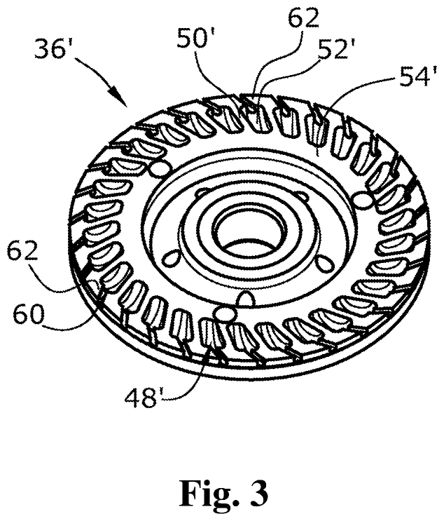

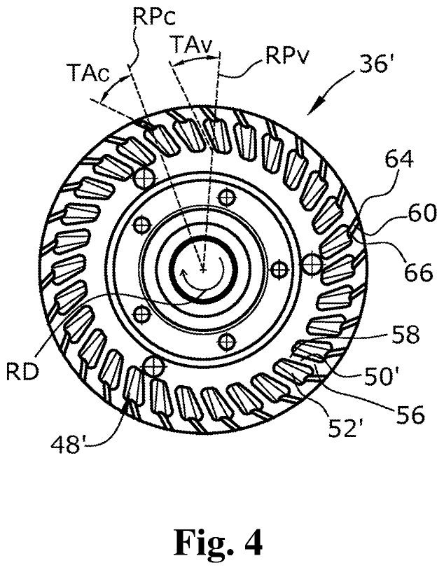

FIGS. 3 and 4 show an alternative auxiliary pump wheel 36′ according to the present invention. In contrast to the auxiliary pump wheel 36, each pumping vane 50′ is here tilted with respect to a corresponding radial plane RPv by a defined vane tilting angle TAv so that a radially inner pumping vane end 58 is circumferentially displaced with respect to a radially outer pumping vane end 56 toward a rotational direction RD of the auxiliary pump wheel 36′.

The auxiliary pump wheel 36′ is also provided with a plurality of discharge channels 60, wherein each pumping chamber 52′ is provided with one discharge channel 60. Each discharge channel 60 is arranged within a radially outer side wall 62 of the corresponding pumping chamber 52′ and fluidically connects the pumping chamber 52′ with the radial outside of the auxiliary pump wheel 36. The discharge channels 60 therefore provide defined fluidics bypasses which limit the high actuation pressure PH provided by the auxiliary pump wheel 36′ to a defined maximum pressure level. Each discharge channel 60 is tilted with respect to a corresponding radial plane RPc by a defined channel tilting angle TAc so that a radially inner discharge channel end 66 is circumferentially displaced with respect to a radially outer discharge channel end 64 toward the rotational direction RD of the auxiliary pump wheel 36′. The channel tilting angle TAc is larger than the vane tilting angle TAv in the shown embodiment of the present invention.

The present invention is not limited to embodiments described herein; reference should be had to the appended claims.

### LIST OF REFERENCE NUMERALS

10 motor vehicle coolant pump
12 pump housing
14 flow channel
16 pump inlet
18 pump outlet
20 coolant pump wheel
22 drive shaft
24 drive wheel
26 control slider
27 control slider side wall
28 outer outlet (of coolant pump wheel 20)
30 hydraulic actuation system
32 auxiliary pump
34 control valve
36;36′ auxiliary pump wheel
38 auxiliary pump housing
40 first pressure chamber
42 second pressure chamber
44 transversal control slider bottom wall
46 pump housing wall
48;48′ pumping channel
50;50′ pumping vanes
52;52′ pumping chambers
54;54′ auxiliary pump wheel surface
56 outer pumping vane end
58 inner pumping vane end
60 discharge channels
62 pumping chamber side wall
64 outer discharge channel end
66 inner discharge channel end
RD rotational direction
RPc radial plane
RPv radial plane
TAc channel tilting angle
TAv vane tilting angle

What is claimed is:

1-9. (canceled)

10. A switchable mechanical motor vehicle coolant pump comprising:
a rotatable drive shaft;
a drive wheel which is co-rotatably connected with the rotatable drive shaft;
a coolant pump wheel comprising a radially outer outlet, the coolant pump wheel being co-rotatably connected with the rotatable drive shaft;
a cylindrical control slider which is configured to be axially shiftable with respect to the coolant pump wheel so that the radially outer outlet is at least partially closeable; and
a hydraulic actuation system which is configured to hydraulically actuate the cylindrical control slider, the hydraulic actuation system comprising,
at least one pressure chamber,
an auxiliary pump comprising an auxiliary pump wheel which is provided integrally with the coolant pump wheel, the auxiliary pump wheel being configured to provide a hydraulic actuation pressure for the at least one pressure chamber, and
a switchable control valve which is configured to control a pressure level within the at least one pressure chamber,
wherein,
the auxiliary pump wheel comprises a ring-shaped pumping channel in which a plurality of pumping vanes is arranged, and
the respective individual pumping vanes of the plurality of pumping vanes are arranged equidistantly along a circumference of the ring-shaped pumping channel so as to define a plurality of equal pumping chambers therebetween.

11. The switchable mechanical motor vehicle coolant pump as recited in claim 10, wherein the auxiliary pump is a side channel pump.

12. The switchable mechanical motor vehicle coolant pump as recited in claim 10, wherein the ring-shaped pumping channel has a circle-segment-shaped cross section.

13. The switchable mechanical motor vehicle coolant pump as recited in claim 10, wherein each pumping vane of the plurality of pumping vanes is arranged completely inside of the ring-shaped pumping channel.

14. The switchable mechanical motor vehicle coolant pump as recited in claim 10, wherein,
each of the plurality of equal pumping chambers comprises a radially outer side wall, and
each radially outer side wall comprises a discharge channel.

15. The switchable mechanical motor vehicle coolant pump as recited in claim 14, wherein each discharge channel is tilted with respect to a corresponding radial plane by a defined channel tilting angle so that a radially inner discharge channel end is circumferentially displaced with respect to a radially outer discharge channel end toward a rotational direction of the auxiliary pump wheel.

16. The switchable mechanical motor vehicle coolant pump as recited in claim 10, wherein each pumping vane of the plurality of pumping vanes is tilted with respect to a corresponding radial plane by a defined vane tilting angle so that a radially outer pumping vane end is circumferentially displaced with respect to a radially inner pumping vane end toward a rotational direction of the auxiliary pump wheel.

17. The switchable mechanical motor vehicle coolant pump as recited in claim 14, wherein,
each discharge channel is tilted with respect to a corresponding radial plane by a defined channel tilting angle so that a radially inner discharge channel end is circumferentially displaced with respect to a radially outer discharge channel end toward a rotational direction of the auxiliary pump wheel,
each pumping vane of the plurality of pumping vanes is tilted with respect to a corresponding radial plane by a defined vane tilting angle so that a radially outer pumping vane end is circumferentially displaced with respect to a radially inner pumping vane end toward a rotational direction of the auxiliary pump wheel, and
the defined channel tilting angle is larger than the defined vane tilting angle.

18. The switchable mechanical motor vehicle coolant pump as recited in claim 10, wherein each pumping vane of the plurality of pumping vanes is configured to extend in a radial plane.
